(19) United States
(12) Patent Application Publication
(10) Pub. No.: US 2011/0032634 A1
(43) Pub. Date: Feb. 10, 2011

(54) CONTROL METHOD AND STORAGE APPARATUS

(75) Inventors: Shigeru SAKAMOTO, Kawasaki (JP); Katsuo Enohara, Kawasaki (JP)

Correspondence Address: Fujitsu Patent Center;Fujitsu Management Services of America, Inc., 2318 Mill Road, Suite 1010, Alexandria, VA, 22314, US

(73) Assignee: FUJITSU LIMITED, Kawasaki-shi (JP)

(21) Appl. No.: 12/850,923

(22) Filed: Aug. 5, 2010

(30) Foreign Application Priority Data
Aug. 10, 2009 (JP) 2009-185609

(51) Int. Cl. G11B 5/02

(52) U.S. Cl. 360/55; G9B/5.026

(57) ABSTRACT

A control method for information processing apparatus includes is provided. The control method includes receiving a lock instruction, locking a library device into a locked state at which insertion, removal and replacement of a medium in the library device is inhibited and/or prevented in response to the lock instruction, generating a map that indicates one or more media in the library device and a position of each of the media, receiving a power-off instruction, and powering off the library device while maintaining the library device in the locked state in response to the power-off instruction.

### CROSS-REFERENCE TO RELATED APPLICATIONS

This application is based upon and claims the benefit of priority of the prior Japanese Patent Application No. 2009-185609, filed on Aug. 10, 2009, the entire contents of which are incorporated herein by reference.

### FIELD

Embodiments discussed herein relate to a control method and a storage apparatus.

### BACKGROUND

Some virtual tape devices discussed in recent years include traditional tape devices and redundant array of independent disks (RAID) storages that allow faster access and that appear to an end user as virtual tape devices.

A conventional configuration in which the virtual tape device includes the RAID storage enables data integrity without continuous use of a tape library device including physical tapes. Because of this, the disadvantages of increased power consumption and relatively short medium life expectancy may be reduced by powering off the tape library device when the physical tapes of the tape library device are not used. However, for a conventional tape library device, as measures against the event that a tape is manually inserted or replaced when the power is off, every time the power is turned on, inventory is performed and a cell map that indicates the tape disposed in the tape library device and the position of the disposed tape (or cell position) is generated.

Similarly, for the tape library device in the virtual tape device, every time the power is turned on, inventory is performed and a cell map is generated, and the cell map is stored and managed in the tape library device. Thus, after the tape library device is powered on and before the virtual tape device is ready to operate, time is required to perform inventory and generate a cell map in the tape library device. Therefore, for the virtual tape device, with a technique of powering off the tape library device when the tape library device is not used and powering on the tape library device to use the tape library device, although the life expectancy of a medium may be increased by a reduction in the power consumption, a significantly long time is required for performing inventory and generating and maintaining a cell map when the tape library device is powered on.

### SUMMARY

A control method for information processing apparatus includes is provided. The control method includes receiving a lock instruction, locking a library device into a locked state at which insertion, removal and replacement of a medium in the library device is inhibited and/or prevented in response to the lock instruction, generating a map that indicates one or more media in the library device and a position of each of the media, receiving a power-off instruction, and powering off the library device while maintaining the library device in the locked state in response to the power-off instruction.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 illustrates an example storage apparatus according to an embodiment of the present invention;

FIG. 2 is a timing diagram for use in describing a power-off sequence and a power-on sequence for a tape library device;

FIG. 3 illustrates how control commands and control information flow in powering off the tape library device;

FIG. 4 illustrates how control commands and control information flow in powering on the tape library device;

FIG. 5 is a flowchart for use in describing in more detail the power-off sequence and the power-on sequence;

FIG. 6 is a flowchart for use in describing in more detail the power-off sequence and the power-on sequence;

FIG. 7 is a flowchart for use in describing in more detail the power-off sequence and the power-on sequence;

FIG. 8 is a flowchart for use in describing in more detail the power-off sequence and the power-on sequence;

FIG. 9 illustrates an operation of the storage apparatus in power saving mode;

FIG. 10 illustrates an operation for power-on in response to the occurrence of writing to the tape library device during power saving mode; and

FIG. 11 illustrates an operation for power-on in response to the occurrence of reading from the tape library device during power saving mode.

### DESCRIPTION OF THE EMBODIMENT(S)

With a power control method and a storage apparatus according to this disclosure, in powering off a library device, the library device is brought to a locked state. When the library device is in a locked state, insertion, removal, and/or replacement of a medium in the library device is inhibited and/or prevented. Once the library device is in a locked state, a media map indicating the positions of media in the library device is generated and stored. The library device is powered off after the media map is stored. This eliminates the need for performing inventory and generating a media map in the library device when the library device is powered on. Accordingly, the time required for processing performed when the library device is powered on may be reduced.

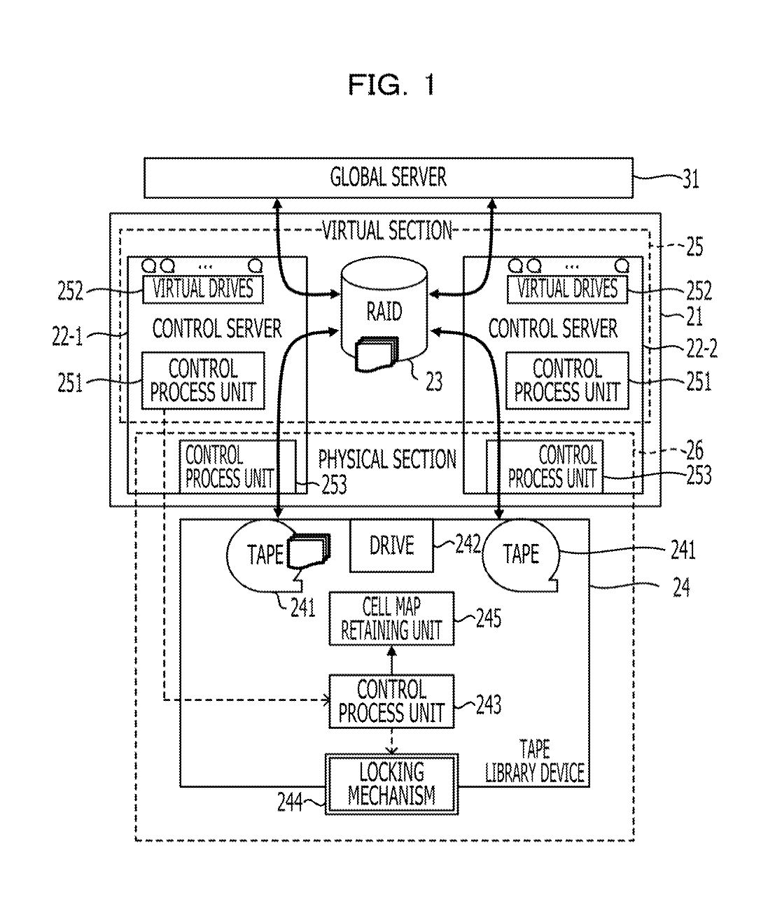

A control method and a storage apparatus according to embodiments of the present invention are described with reference to FIG. 1 and subsequent drawings.

FIG. 1 illustrates an example storage apparatus according to an embodiment of the present invention. In FIG. 1, the thick solid line arrows indicate an example of how data flows, and the broken line arrow indicates an example of how a cell map (or control information) flows. In the storage apparatus illustrated in FIG. 1, a virtual tape device 21 is connected to a global server (or host) 31. The virtual tape device 21 includes, for example, control servers 22-1 and 22-2, a RAID storage 23, and a tape library device 24. Each of the control servers 22-1 and 22-2 includes a first control process unit 251 for use in a virtual section, a plurality of virtual drives 252, and a second control process unit 253 for use in a physical section.

The virtual tape device 21 is divided into a virtual section 25 and a physical section 26 indicated by being surrounded by the broken lines. The virtual section 25 includes the first control process unit 251 and virtual tape drives 252 in each of the control servers 22-1 and 22-2 and the RAID storage 23 and has the function of causing the RAID storage 23 to appear as a virtual tape device to an end user. The RAID storage 23 functions as a so-called tape volume cache (TVC). The physical section 26 includes the second control process unit 253 in each of the control servers 22-1 and 22-2 and the tape library device 24 and has the function of writing data stored in the RAID storage 23 to the tape library device 24.

The virtual tape drives 252 used in the virtual section 25 according to the present embodiment virtually form a plurality of 36-track tape drives (2 GB). A tape drive of the linear tape-open (LTO) Ultrium standard or a tape drive of the LTO Accelis standard may be used as one or more tape drives disposed in the tape library device 24 in the physical section 26. The capacity of a tape of the LTO Ultrium standard or LTO Accelis standard is 800 GB. Data corresponding to a plurality of virtual tapes written in the virtual section 25 may be collectively written to a single tape 241 in the tape library device 24 in the physical section 26. For example, the tape 241 may be a magnetic tape forming a storage medium.

The virtual section 25 uses the RAID storage 23, thus allowing fast access from the global server 31. Data stored in the RAID storage 23 is reflected in the tape library device 24 in the physical section 26, and data is managed in a duplicate way. In the present embodiment, the two control servers 22-1 and 22-2 are disposed. However, N control servers (N is a natural number more than one) can be disposed so as to enable data to be managed in the N-fold way.

Each of the control servers 22-1 and 22-2 may operate as either one of a main server and a sub-server, for example. The main server performs processing of the first control process unit 251 for controlling the virtual section 25. The main server also performs processing of the physical section 26.

The power consumption in operation of the virtual tape device 21 is larger than that of other input and output (I/O) devices like a tape library device because the virtual tape device 21 simultaneously may operate a plurality of hardware components. The tape drive of the tape library device 24 in the physical section 26 writes a plurality of virtualized logical volumes, so the number of accesses to the tape is larger than ordinary tape library device. This results in a relatively short life expectancy of the tape (i.e., medium) than the ordinary tape library device.

The configuration in which the virtual tape device 21 includes the RAID storage 23 enables data integrity without continuous use of the tape library device 24. Because of this, the disadvantages of increased power consumption and relatively short medium life expectancy may be reduced by powering off the tape library device 24 when the tape library device 24 is not used.

However, conventionally, as measures against the event that the tape 241 is manually inserted or replaced when the power is off, inventory is performed and a cell map that indicates the tape 241 disposed in the tape library device 24 and the position of each tape (or cell position) is generated and managed every time the power is turned on. As such, conventionally, each time power is turned on, the inventory is performed and the cell map is generated, and thus, the tape library device cannot be accessed until after a time duration required for performing the inventory and generating the cell map.

The inventors, through their own inventive efforts have identified, that it is not always necessary for the tape library device 24 connected to the virtual tape device 21 to perform inventory when powering-on. Rather, the inventory may only be performed in specific cases according to an example embodiment. For the present embodiment, when the tape library device 24 is not used, that is, when the storage apparatus is in power saving mode, the tape library device 24 is brought in a locked state by a locking mechanism 244, a cell map is generated, and, after the cell map is stored in the virtual tape device 21, the tape library device 24 is powered off. In the locked state, for example, the tape library device 24 is locked such that the tape 241 cannot be normally removed from the tape library device 24. Thus, the tape 241 cannot be normally inserted into the tape library device 24, and the tape 241 within the tape library device 24 cannot be normally replaced. Stated differently, the tape 241 is inhibited and/or prevented from being removed or replaced. The cell map may be managed in at least one of the control servers 22-1 and 22-2 in the virtual tape device 21.

The locking mechanism 244 may be a mechanical, electrical, and electro-mechanical locking mechanism. For example, the may be a physical, mechanical lock that prevent a door of the library device 24 from being opened. Alternatively, the locking mechanism 244 may be an electrical locking mechanism. For example, the electrical locking mechanism may be an electric switch preventing power from reaching a circuit used to control the opening and closing of the library device 24.

In powering on the tape library device 24, after the tape library device 24 is powered on and a cell map stored in the virtual tape device 21 is set in a cell map retaining unit 245 in the tape library device 24, the locked state by the locking mechanism 244 is released and the tape library device 24 is brought to an unlocked state. In the unlocked state, the tape 241 may be inserted into the tape library device 24, and the tape 241 in the tape library device 24 may be replaced. As described below, a third control process unit 243 in the tape library device 24 generates a cell map, transfers it to the virtual tape device 21, and controls the locked state and unlocked state of the tape library device 24 by the locking mechanism 244.

For example, when the tape library device 24 has a door (not illustrated), the tape library device 24 may be brought to the locked state or unlocked state by the locking mechanism 244 controlling the locking and unlocking function provided on the door. In this case, if a cell map is managed in the virtual tape device 21, keeping the door locked inhibits and/or prevents the door from being opened. Therefore, manual insertion and replacement of the tape 241 in the tape library device 24 may be inhibited and/or prevented. The above-described operations and locking mechanism may avoid a mismatch occurring between a cell map managed in the virtual tape device 21 and an actual cell map in the tape library device 24. If the door is in the unlocked state, a user can open the door and insert or replace the tape 241 in the tape library device 24.

In such a way, in power saving mode at which the start-up time of the tape library device 24 is shortened, the power to the tape library device 24 is off, and the tape library device 24 is powered on only when processing of the tape library device 24 is required, for example. With the present embodiment, the power consumption of the entire storage apparatus may be reduced by the amount corresponding to the powering off the tape library device 24, and the medium life expectancy of the tape 241 may be extended. Because a cell map is generated after the tape library device 24 is brought to the locked state and the generated cell map is stored in the virtual tape device 21, it is not always necessary to perform some processes requiring time, such as performing an inventory and generating and storing of a cell map. Accordingly, the start-up time of the tape library device 24 may be shortened.

In power-off states other than power saving mode, for example, at a maintenance task for the storage apparatus, the locking function of the tape library device 24 may be disabled.

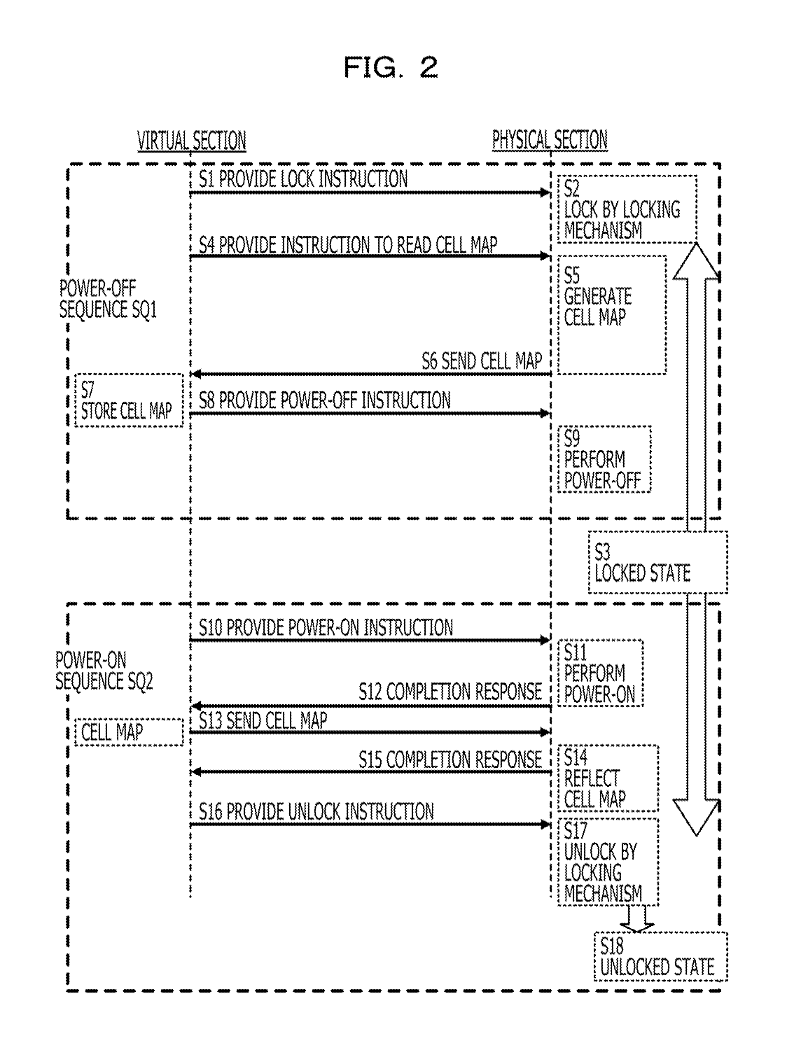

FIG. 2 is a timing diagram for use in describing a power-off sequence SQ1 and power-on sequence SQ2 for the tape library device 24. For the sake of convenience of description, in this embodiment, the first control process unit 251 of the control server 22-1 controls power-off and power-on to the tape library device 24. In this case, the first control process unit 251 of the control server 22-2 can be omitted. However, with the first control process unit 251 of the control server 22-2, even if the control server 22-1 is out of order, for example, the control server 22-2 can control power-off and power-on to the tape library device 24 in place of the control server 22-1. The power-off sequence SQ1 can be executed when the storage apparatus is set to power saving mode, for example. The power-on sequence SQ2 can be executed when the storage apparatus is set to normal operation mode from the power saving mode, for example.

In the power-off sequence SQ1 illustrated in FIG. 2, at operation S1, the first control process unit 251 issues a lock instruction to the third control process unit 243 of the tape library device 24. At operation S2, in response to the lock instruction, the control process unit 243 of the tape library device 24 causes the locking mechanism 244 to bring the tape library device 24 to the locked state. Alternatively, the locking mechanism 244 may directly respond to the lock instruction and bring the tape library device 24 to the locked state. At operation S3, the locking mechanism 244 causes the tape library device 24 to be in the locked state. If the tape library device 24 has a door, the door is locked and cannot be normally opened in the locked state. Until the tape library device 24 is unlocked by the release of the locked state after the tape library device 24 is powered on, the locked state at which insertion and replacement of the tape 241 in the tape library device 24 is inhibited and/or prevented is maintained.

At operation S4, the first control process unit 251 issues an instruction to read a cell map to the third control process unit 243 of the tape library device 24. At operation S5, in response to the instruction to read the cell map, the third control process unit 243 of the tape library device 24 generates the cell map. At operation S6, the third control process unit 243 of the tape library device 24 sends the generated cell map to the first control process unit 251. In generating the cell map in the tape library device 24, the cell map may be temporarily retained in a volatile memory or the like (not illustrated) in the tape library device 24 and then sent to the first control process unit 251.

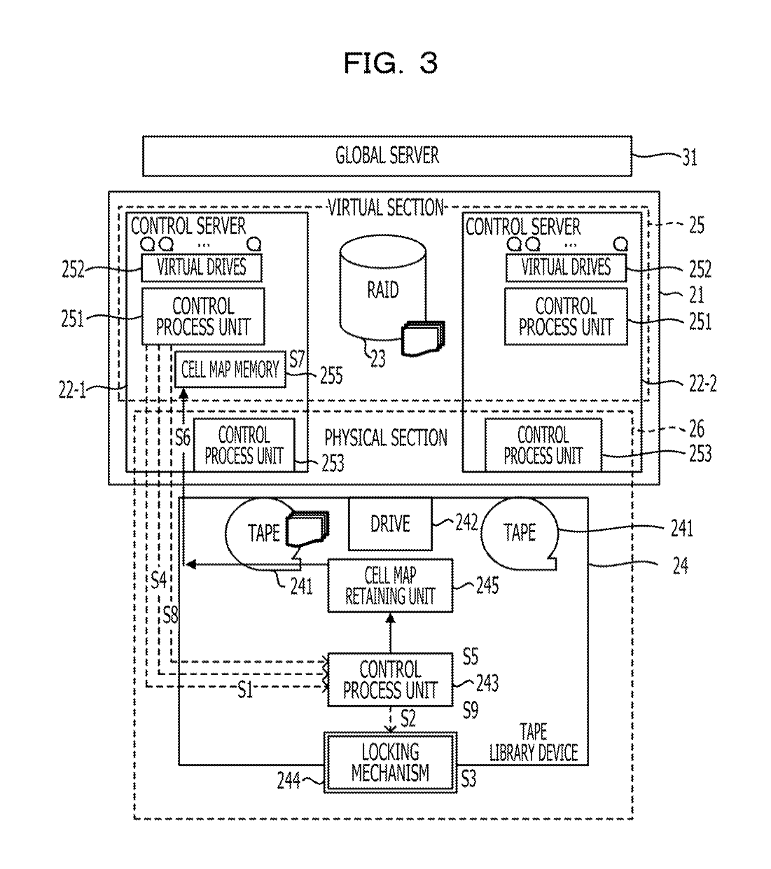

At operation S7, the first control process unit 251 stores the cell map in a cell map memory 255 (see, for example, FIG. 3) in the control server 22-1. At operation S8, the first control process unit 251 issues a power-off instruction to the third control process unit 243 of the tape library device 24. At operation S9, in response to the power-off instruction, the third control process unit 243 of the tape library device 24 performs power-off and sets the tape library device 24 at a standby state.

FIG. 3 illustrates an example of how control commands and control information flow when the tape library device 24 is powered off. In FIG. 3, the same reference numerals are used to represent the same components as described with respect to FIG. 1, and the same reference numerals are used to represent the same operations as described with respect to FIG. 2, and the detailed description thereof is omitted for the sake of brevity. In FIG. 3, the broken line arrows indicate an example of how instructions (or control commands) flow, and the solid line arrows indicate an example of how a cell map (or control information) flows.

In the power-on sequence SQ2 illustrated in FIG. 2, at operation S10, the first control process unit 251 issues a power-on instruction to the third control process unit 243 of the tape library device 24. At operation S11, in response to the power-on instruction, the third control process unit 243 of the tape library device 24 performs power-on without performing inventory. The power-on instruction issued to the third control process unit 243 may be the one specifying that inventory is not to be performed, for example. At operation S12, the third control process unit 243 of the tape library device 24 notifies the first control process unit 251 of completion of the power-on. At operation S13, in response to the notification of completion of the power-on, the first control process unit 251 notifies the cell map retaining unit 245 of the tape library device 24 of the cell map stored in the cell map memory 255. At operation S14, the cell map retaining unit 245 of the tape library device 24 retains the received cell map, thus reflecting the cell map at the last power-off in the tape library device 24. At operation S15, when ending reflection of the cell map in the cell map retaining unit 245, the control process unit 243 of the tape library device 24 issues notification indicating that the reflection of the cell map is completed (or completion response) to the first control process unit 251.

At operation S16, in response to the completion response, the control process unit 251 issues an unlock instruction to the third control process unit 243 of the tape library device 24. At operation S17, in response to the unlock instruction, the control process unit 243 of the tape library device 24 causes the locking mechanism 244 to release the locked state and bring the tape library device 24 to the unlocked state. At operation S18, the locking mechanism 244 causes the tape library device 24 to be in the unlocked state. If the tape library device 24 has a door, the door is unlocked and allowed to be open in the unlocked state. When the locked state is released and the tape library device 24 is brought to the unlocked state after the tape library device 24 is powered on, insertion of the tape 241 into the tape library device 24 and replacement of the tape 241 in the tape library device 24 are allowed.

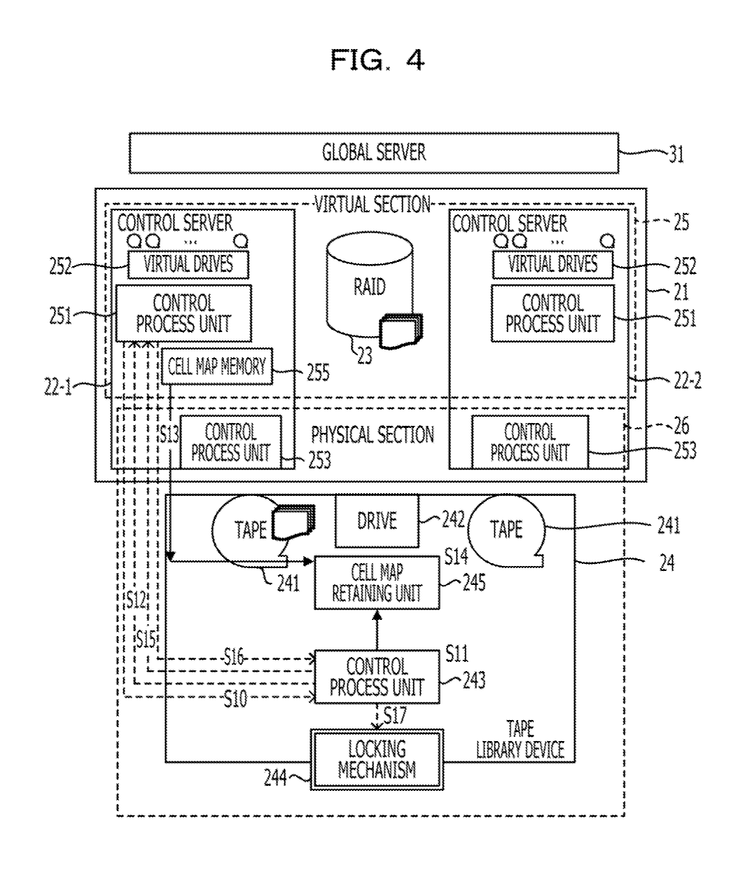

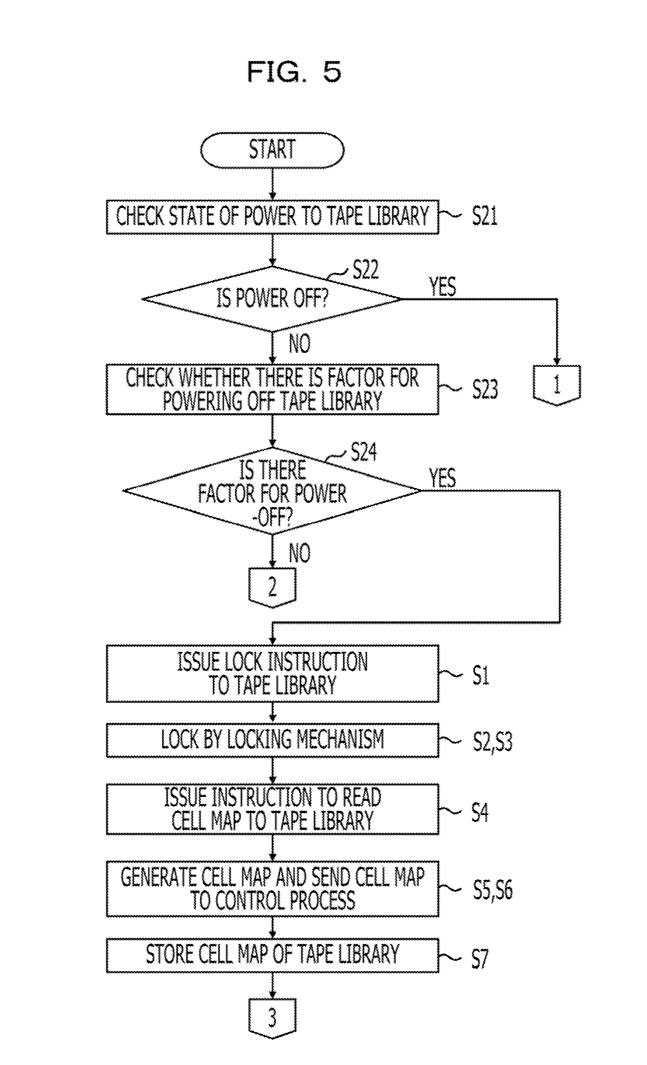

FIG. 4 illustrates an example of how control commands and control information flow when the tape library device 24 is powered on. In FIG. 4, the same reference numerals are used to represent the same components described with respect to FIG. 1, the same reference numerals are used to represent the same operations as described with respect to FIG. 2, and the detailed description thereof is omitted for the sake of brevity. In FIG. 5, the broken line arrows indicate an example of how instructions (or control commands) flow, and the solid line arrows indicate an example of how a cell map (or control information) flows.

Next, the power-off sequence SQ1 and the power-on sequence SQ2 are described in more detail with reference to FIGS. 5 to 8. FIGS. 5 to 8 are flowcharts for describing in more detail the power-off sequence and the power-on sequence according to an example embodiment. In FIGS. 5 to 8, the same reference numerals are used in the same operations as in FIG. 2, and the detailed description thereof is omitted for the sake of brevity.

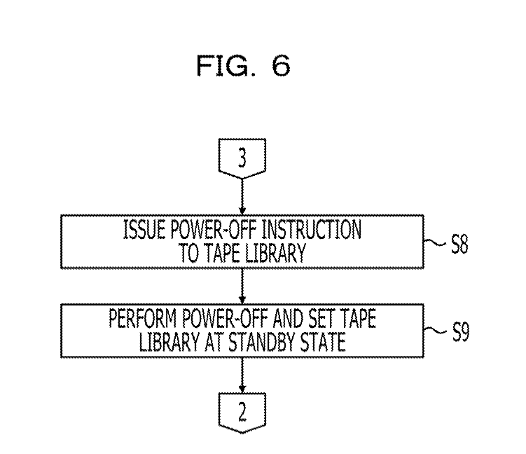

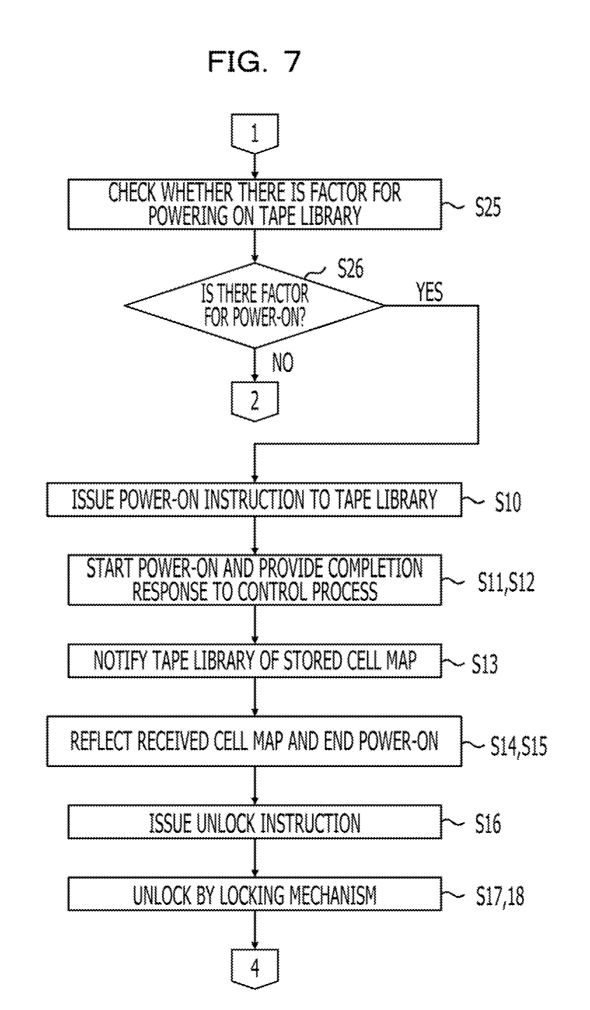

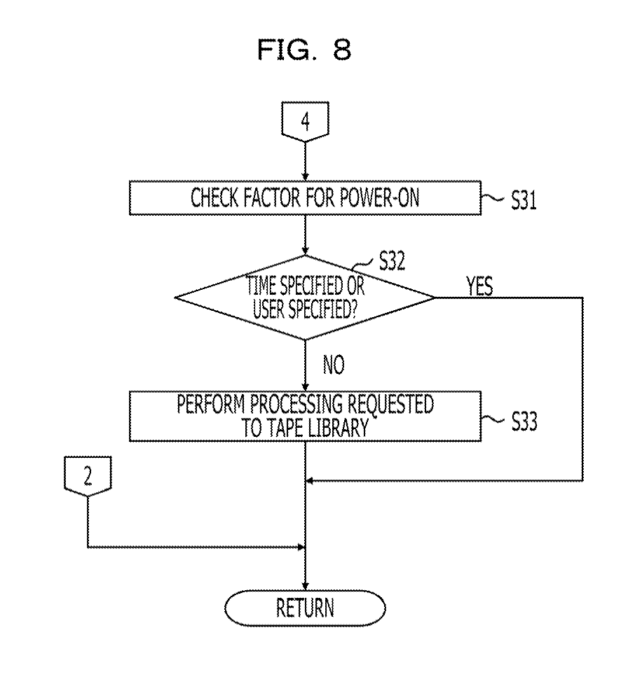

The processing in FIGS. 5 to 8 is called by the first control process unit 251 of the virtual tape device 21. In FIG. 5, at operation S21, the first control process unit 251 checks the state of the power to the tape library device 24. At operation S22, the first control process unit 251 determines whether the power to the tape library device 24 is off. If the determination at the operation S22 is YES, the flow proceeds to operation S25 illustrated in FIG. 7. If the determination at the operation S22 is NO, the first control process unit 251 checks at operation S23 whether there is a factor such as frequency of I/O access or operating time of the tape library device for powering off the tape library device 24. At operation S24, the first control process unit 251 determines whether there is a factor for powering off the tape library device 24. If the determination at the operation S24 is YES, the flow proceeds to the operation 51; if the determination at the operation S24 is NO, the flow returns to the processing of the first control process unit 251, which is the caller, as illustrated in FIG. 8. After the operation S7, the flow proceeds to the operation S8 illustrated in FIG. 6. After the operation S9, the flow returns to the processing of the first control process unit 251, which is the caller.

In FIG. 7, at the operation S25, the control process unit 251 checks whether there is a factor such as receiving an I/O access for powering on the tape library device 24. At operation S26, the control process unit 251 determines whether there is a factor for powering on the tape library device 24. If the determination at the operation S26 is YES, the flow proceeds to the operation S10. If the determination at the operation S26 is NO, the flow returns to the processing of the first control process unit 251, which is the caller. After the operations S17 and S18, the flow proceeds to operation S31 illustrated in FIG. 8.

In FIG. 8, at the operation S31, the first control process unit 251 checks the factor for powering on the tape library device 24. At operation S32, the first control process unit 251 determines whether the factor for power-on is a time-specified one or a user-specified one. If the determination at the operation S32 is NO, at operation S33, the first control process unit 251 performs processing requested to the tape library device 24, that is, writing data to the tape 241 by a drive 242 of the tape library device 24 or reading data from the tape 241 by the drive 242 of the tape library device 24, for example. If the determination at the operation S32 is YES or after the operation S33, the flow returns to the processing of the first control process unit 251, which is the caller.

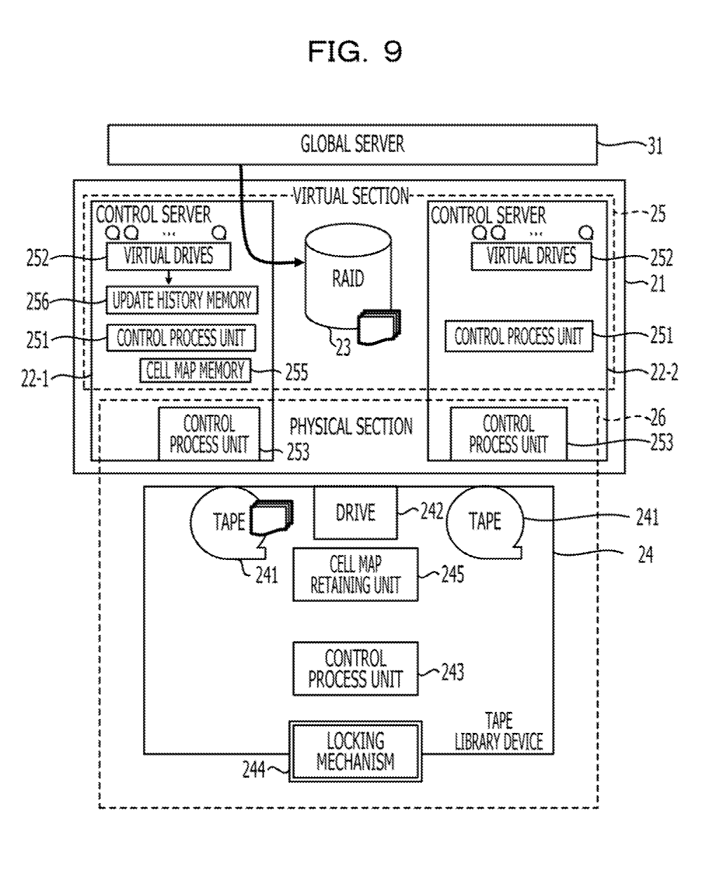

Next, an operation of the storage apparatus in power saving mode, that is, in a state where the power to the tape library device 24 is off is described with reference to FIG. 9. FIG. 9 illustrates the operation of the storage apparatus in power saving mode. In FIG. 9, the same reference numerals are used to represent the same components as described with respect to FIG. 1, and the detailed description thereof is omitted for the sake of brevity. In FIG. 9, the thick solid line arrow indicates an example of how data flows.

In powering on the virtual tape device 21, all hardware components of the virtual tape device 21 start up, and after the start-up, the first control process unit 251 provides the third control process unit 243 of the tape library device 24 with a power-off instruction. This power-off complies with the previously-described power-off sequence SQ1 and thus, a repeat description of the sequence SQ1 is omitted for the sake of brevity. The first control process unit 251 stores a cell map generated in the tape library device 24 in the cell map memory 255.

In the control server 22-1, an update history memory 256 for storing an update history of logical volumes in the form of an update history table is disposed. In updating a logical volume, an update status is recorded in the update history table in the update history memory 256. This update history table is managed per tape (e.g., per LTO tape). Even when logical volumes are different, if they are associated with the same tape 241, the same counter (not illustrated) in the control process unit 251 is incremented. Accordingly, the update history of logical volumes is converted into the number of accesses to the tape 241, and it is recorded in the update history table. In reading a logical volume, if that logical volume exists in the RAID storage 23, the update history table is not accessed.

An operation occurring when processing of the tape library device 24 is required while the storage apparatus operates in power saving mode is described below. In this case, if any one of the following conditions c1 to c3 is satisfied, the virtual tape device 21 powers on the tape library device 24 and operate the tape library device 24.

Condition c1: In the update history of logical volumes, the number of updates per tape exceeds a specified value.

Condition c2: An access to a logical volume that does not exist in the RAID storage 23 is requested.

Condition c3: A preload utility for preloading data to a tape in the tape library device 24 is activated.

The power-on to the tape library device complies with the above previously-described power-on sequence SQ2. The tape library device 24 starts up on the basis of a cell map received from the first control process unit 251, for example.

After powering on the tape library device 24, processing that triggered the power-on is first performed. Then, all entered processing to the tape library device 24 at that time (e.g., migration) is completed. After that, the tape library device 24 may be powered off again in accordance with the above power-off sequence SQ1, and the storage apparatus may be set to power saving mode.

The tape library device 24 may be powered on in response to a trigger, such as a time-specified trigger (e.g., starting time of night batch processing) or a user-specified trigger (e.g., a trigger specified by a command), in consideration of user environment. For example, at a specified time or at the time when a command is input from the global server 31, the tape library device 24 may start up in accordance with the previously-described power-on sequence SQ2. After the tape library device 24 is powered on, a portion and/or all entered processing to the tape library device 24 (e.g., migration) is completed, and the power-on state is maintained. In this case, the tape library device 24 is powered off in accordance with the above power-off sequence SQ1 in response to a time specification or user specification, for example.

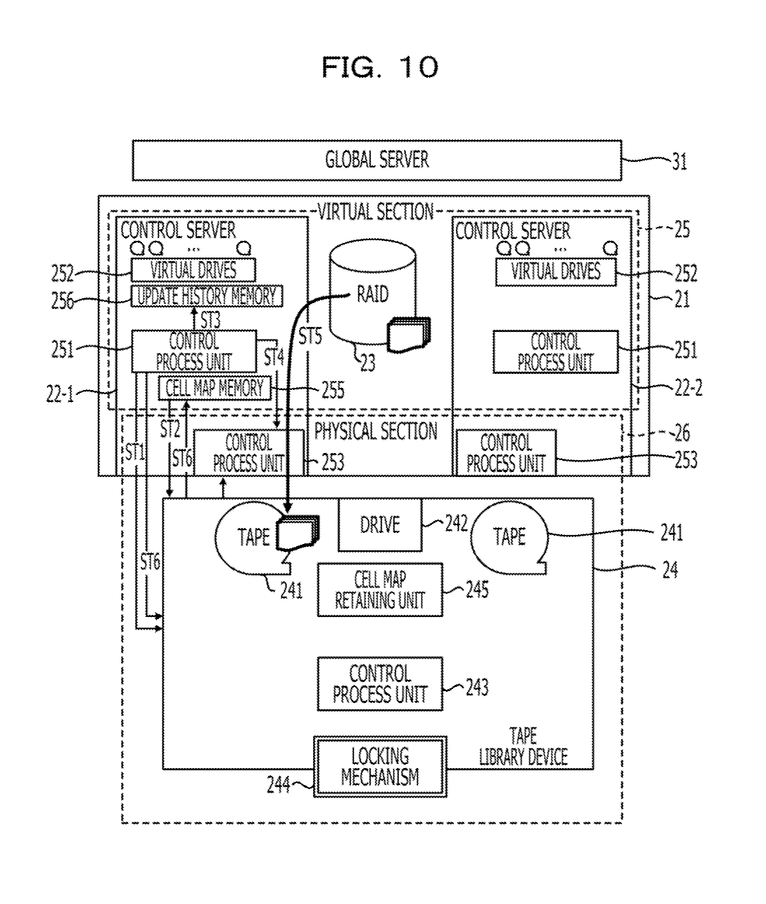

Next, an operation for power-on in response to the occurrence of writing to the tape library device 24 while the storage apparatus operates in power saving mode is described below with reference to FIG. 10. FIG. 10 illustrates the operation for power-on in response to the occurrence of writing to the tape library device 24 in power saving mode. In FIG. 10, the same reference numerals are used to represent the same components as described with respect to FIGS. 1, 3, 4, and 9, and thus the detailed description thereof is omitted. In FIG. 10, the solid line arrows indicate an example of how instructions (or control commands) flow, and the thick solid line arrow indicates an example of how data flows.

A power-on in response to the occurrence of writing to the tape library device 24 may arise when the number of updates per tape in an update history of logical volumes exceeds a specified value, for example. In this case, the following processing ST1 to ST6 is performed.

ST1: The first control process unit 251 starts the previously-described power-on sequence SQ2.

ST2: The tape library device 24 is notified of a cell map by the first control process unit 251 and starts up.

ST3: The first control process unit 251 refers to an update history of logical volumes recorded in the update history memory 256 and identifies the presence of a logical volume to be subjected to migration, for example.

ST4: The first control process unit 251 issues an instruction to write back the logical volume to be subjected to migration to the second control process unit 253 in the physical section 26.

ST5: The second control process unit 253 in the physical section 26 writes the logical volume to be subjected to migration to the tape 241 by the use of the drive 242 in the tape library device 24.

ST6: When writeback of the logical volume is completed, the first control process unit 251 powers off the tape library device 24 in accordance with the previously-described power-off sequence SQ1.

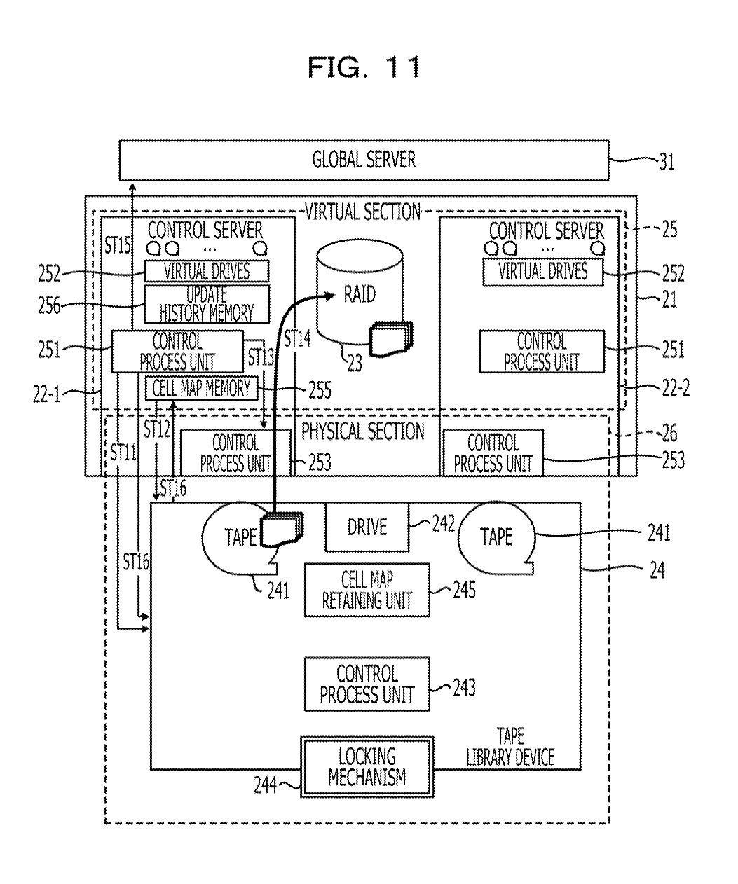

Next, an operation for power-on in response to the occurrence of reading from the tape library device 24 while the storage apparatus operates in power saving mode is described below with reference to FIG. 11. FIG. 11 illustrates the operation for power-on in response to the occurrence of reading from the tape library device 24 in power saving mode. In FIG. 11, the same reference numerals are used to represent the same components as described with respect to FIG. 10, and the detailed description thereof is omitted for the sake of brevity. In FIG. 12, the solid line arrows indicate an example of how instructions (or control commands) flow, and the thick solid line arrow indicates an example of how data flows.

A power-on, in response to the occurrence of reading from the tape library device 24, arises when an access to a logical volume that does not exist in the RAID storage 23 is requested or when a preload utility is activated, for example. In this case, the following processing ST11 to ST16 is performed.

ST11: The first control process unit 251 starts the previously-described power-on sequence SQ2.

ST12: The tape library device 24 is notified of a cell map by the control process unit 251 and starts up.

ST13: The first control process unit 251 issues an instruction to read that logical volume to the second control process unit 253 in the physical section 26.

ST14: The third control process unit 243 in the tape library device 24 reads the logical volume indicated by the first control process unit 251 to the RAID storage 23. This flow is indicated by the thick solid line in FIG. 11.

ST15: If desired and/or necessary, the control process unit 251 may issue, to the global server 31, a completion notification indicating that reading of the logical volume to the RAID storage 23 is completed.

ST16: When writeback is completed, the control process unit 251 may power off the tape library device 24 in accordance with the previously-described power-off sequence SQ1.

The storage apparatus may power on the tape library device 24 while operating in power saving mode in response to an instruction from a user in the case where there is time specification (e.g., starting time of night batch processing) or user specification (e.g., an instruction specified by a command), for example. In this case, at a specified time or at the time when a command is input, the tape library device 24 starts up in accordance with the previously-described power-on sequence SQ2. After the tape library device 24 is powered on, a portion and/or all entered processing to the tape library device 24 (e.g., migration) is completed, and the power-on state may be maintained. Further, the tape library device 24 may be powered off in accordance with the previously-described power-off sequence SQ1 in response to time specification or user specification, for example.

With the above embodiment(s), the power saving advantages achieved by powering on the tape library device being part of the physical section of the virtual tape device only when processing is needed are obtainable. In addition, the advantages of extending a medium life expectancy of a tape achieved by a reduction in the number of accesses to the tape in the virtual tape device are obtainable.

For the above embodiment, a cell map generated in the tape library device 24 is managed in the virtual tape device 21. However, a cell map may be managed in the tape library device 24 as long as the tape library device 24 is in a locked state before the cell map is generated and the power is turned off after the cell map is generated, for example. In this case, at the operation S5 illustrated in FIG. 2, the generated cell map is retained in the cell map retaining unit 245 in the tape library device 24, and at the operation S6, without sending the cell map, completion of generating the cell map may be simply notified to the control process unit 251 in the virtual tape device 21. In power-on, after power-on in response to a power-on instruction from the control process unit 251 in the virtual tape device 21 at the operation S11 illustrated in FIG. 2, the tape library device 24 itself may cause the control process unit 243 to control the locking mechanism 244 to bring the tape library device 24 to an unlocked state at an operation corresponding to the operation S17. Therefore, the operations S13, S14, S15, and S16 could be omitted.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

1. A control method for an information processing apparatus comprising:
receiving a lock instruction;
locking a library device into a locked state in which insertion, removal and replacement of a medium in a library device is inhibited in response to the lock instruction;
generating a map that indicates one or more media in the library device and a position of each of the media;
receiving a power-off instruction; and
powering off the library device while maintaining the library device in the locked state in response to the power-off instruction.

2. The control method according to claim 1, further comprising:
receiving a virtual medium instruction from a virtual medium device;
generating the map in response to the virtual medium instruction; and
sending the map to the virtual medium device.

3. The control method according to claim 2, further comprising:
receiving a power-on instruction;
receiving the map from the virtual medium device;
powering on the library device in response to the power-on instruction; and
setting the map received from the virtual medium device in a map memory in the library device.

4. The control method according to claim 3, further comprising:
receiving an unlock instruction from the virtual medium device; and
unlocking the library device such that the library device is brought to an unlocked state by releasing the locked state in response to the unlock instruction.

5. The control method according to claim 1, further comprising:
receiving a power-on instruction; and
powering on the library device in response to the power-on instruction without performing an inventory to generate the map.

6. The control method according to claim 1, wherein the generating generates the map after the library device is locked into the locked state and prior to the powering-off of the library device.

7. The control method according to claim 6, further comprising:
powering on the library device without performing an inventory and controlling access to the library device based on the map generated after the library device was locked into the locked state and prior to the powering-off of the library device.

8. A storage apparatus for storing data comprising:
a library device to house at least one medium;
a locking mechanism to set the library device to a locked state in which insertion, removal, and replacement of the at least one medium is inhibited in response to a lock instruction; and
a control process unit to receive a power-off instruction and the lock instruction, to generate a map that indicates the at least one medium in the library device and a position of each of the at least one medium, and to power off the library device while the library device is maintained in the locked state in response to the power-off instruction.

9. The storage apparatus for storing data according to claim 8, further comprising:
a virtual medium device, and
the control process unit receives a virtual medium instruction from the virtual medium device, generates the map in response to the virtual medium instruction, and sends the map to the virtual medium device.

10. The storage apparatus for storing data according to claim 9, wherein the virtual medium device includes a memory and a memory control unit to store the map received from the library device in the memory.

11. The storage apparatus for storing data according to claim 10, wherein the library device further includes a map storing unit, and
the control process unit receives a power-on instruction, receives the map from the virtual medium device, powers on the library device in response to the power-on instruction and stores the map received from the virtual medium device in the map storing unit.

12. The storage apparatus for storing data according to claim 11, wherein the control process unit receives an unlock instruction form the virtual medium device, releases the locked state of the library device, and brings the library device to an unlocked state in response to the unlock instruction.

13. The storage apparatus for storing data according to claim 12, wherein the medium in the library device is a tape, and
the virtual medium device includes a redundant array of independent disks (RAID) storage, and the RAID storage is identified as a virtual tape device by a higher-level device.

14. The storage apparatus for storing data according to claim 8, wherein the control process unit receives a power-on instruction; and powers on the library device in response to the power-on instruction without performing an inventory to generate the map.

15. The storage apparatus for storing data according to claim 8, wherein the map after the library device is locked into the locked state and prior to the powering-off of the library device.

16. The control method according to claim 15, further comprising:
the process control unit powers on the library device without performing an inventory and controls access to the library device based on the map generated after the library device was locked into the locked state and prior to the powering-off of the library device.
